(19) United States
(12) Patent Application Publication
(10) Pub. No.: US 2025/0185745 A1
(43) Pub. Date: Jun. 12, 2025

(54) Snowboard Tracking Helmet Device

(71) Applicant: Jason Simmons, Hillsboro, OR (US)

(72) Inventor: Jason Simmons, Hillsboro, OR (US)

(21) Appl. No.: 18/958,004

(22) Filed: Nov. 25, 2024

Related U.S. Application Data
(60) Provisional application No. 63/607,799, filed on Dec. 8, 2023.

(51) Int. Cl. A42B 3/04; A42B 3/22; G02B 27/01

(52) U.S. Cl. CPC A42B 3/0433; A42B 3/22; G02B 27/0172

(57) ABSTRACT

A snowboard tracking helmet device is disclosed, which is a helmet for snowboarding or skiing that prevents head injuries, suffocation due to avalanches, and facilitates learning new techniques while riding, as described. The snowboard tracking helmet device comprises a helmet component that is configured in a rounded shape similar to a conventional snowboard helmet. The helmet component includes Bluetooth capabilities which allows users to link up to their smart devices and issue verbal commands to activate the features of the heads-up display. The helmet component comprises a variety of sensors including a vital sign monitor, oxygen sensor, sensors that receive verbal commands, GPS capabilities, and an impact sensor. An avalanche beacon face shield on the helmet component provides a heads-up display to demonstrate various snowboarding tricks in real time, provide a map of the location and provide UV protection.

### CROSS-REFERENCE TO RELATED APPLICATION

The present application claims priority to, and the benefit of, U.S. Provisional Application No. 63/607,799, which was filed on Dec. 8, 2023, and is incorporated herein by reference in its entirety.

### FIELD OF THE INVENTION

The present invention relates generally to the field of snowboard tracking helmet devices. More specifically, the present invention relates to a tracking helmet for better communication and view of terrain while snowboarding or skiing. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in snowboard tracking helmet devices. Generally, not wearing a helmet while snowboarding or skiing can increase the risk of serious injury in the event of a fall or collision. The most significant risk is the potential for head injuries. Snowboarding involves a combination of speed, varied terrain, and the possibility of collisions with other riders, trees, rocks, or hard-packed snow. In the absence of a helmet, the head is vulnerable to impact which can result in concussions, skull fractures, or other traumatic brain injuries. In extreme cases, head injuries sustained without a helmet can be fatal.

Head injury is an inevitable risk in snow sports or winter sports. In snow sports such as skiing, snowboarding, or sledding, concussions account for a significant portion of the injuries. Athletes who engage in snow sports often trek down slopes or on uneven terrain, which can increase the likelihood of a fall occurring. Wearing a properly fitted helmet while engaging in snow sports may prevent or reduce the severity of head injuries or concussions resulting from such falls. Poorly designed headgear may be insufficient in providing protection against concussions and can often give players a false sense of security while playing.

Accordingly, there is a demand for an improved snowboard tracking helmet device that prevents head injuries and other emergency-type situations by absorbing the force of an impact. More particularly, there is a demand for a snowboard tracking helmet device that features multiple sensors that would detect impact and provide oxygen, if needed.

Therefore, there exists a long felt need in the art for a snowboard tracking helmet device that provides users with a tracking helmet for better communication and view of terrain while snowboarding or skiing. There is also a long felt need in the art for a snowboard tracking helmet device that prevents head injuries and other emergency-type situations by absorbing the force of the impact. Further, there is a long felt need in the art for a snowboard tracking helmet device that features multiple sensors that would detect impact and provide oxygen, if needed, through vital sign detection. Moreover, there is a long felt need in the art for a device that offers tracking location, map navigation, weather alerts, and real-time tutorial demonstrations. Further, there is a long felt need in the art for a snowboard tracking helmet device that enhances communication and improves overall situational awareness. Finally, there is a long felt need in the art for a snowboard tracking helmet device that enables users to communicate and alert emergency response quickly and easily.

The subject matter disclosed and claimed herein, in one embodiment thereof, comprises a snowboard tracking helmet device. The device is a helmet for snowboarding or skiing that prevents head injuries, suffocation due to avalanches, and facilitates learning new techniques while riding, as described. The snowboard tracking helmet device comprises a helmet component that is configured in a rounded shape similar to a conventional snowboard helmet. The helmet component includes Bluetooth capabilities which allows users to link up to their smart devices and issue verbal commands to activate the features of the heads-up display. The helmet component comprises a variety of sensors including a vital sign monitor, oxygen sensor, sensors that receive verbal commands, GPS capabilities, and an impact sensor. The oxygen sensor will communicate with a compact oxygen tank in the presence of low oxygen. The impact sensor will communicate with backpacks equipped for avalanches. An avalanche beacon face shield on the helmet component provides a heads-up display to demonstrate various snowboarding tricks in real time, provide a map of the location and provide UV protection. The face shield is also fog resistant.

In this manner, the snowboard tracking helmet device of the present invention accomplishes all of the forgoing objectives and provides users with a device that prevents head injuries. The device is a snowboard tracking helmet device that features multiple sensors that would detect impact and provide oxygen.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a snowboard tracking helmet device. The device is a helmet for snowboarding or skiing with a variety of sensors. The snowboard tracking helmet device comprises a helmet component that includes Bluetooth capabilities which allows users to link up to their smart devices and issue verbal commands to activate the features of the heads-up display. The helmet component comprises a variety of sensors including a vital sign monitor, oxygen sensor, sensors that receive verbal commands, GPS capabilities, and impact sensors. Further, an avalanche beacon face shield on the helmet component provides a heads-up display to demonstrate various snowboarding tricks in real time, provide a map of the location, and provide UV protection.

In one embodiment, the snowboard tracking helmet device prevents head injuries, suffocation due to avalanches, and facilitates learning new techniques while riding. Further, the snowboard tracking helmet device provides better communication and view of the terrain while snowboarding or skiing. It enhances communication and improves overall situational awareness. Further, it enables users to communicate and alert emergency response quickly and easily. Thus, the device offers tracking location, map navigation, weather alerts and real-time tutorial demonstrations, etc.

In one embodiment, the snowboard tracking helmet device comprises a helmet component that is configured in a rounded shape similar to a conventional snowboard helmet. Typically, the helmet component is a snowboard helmet, but can be any suitable snow sport helmet as is known in the art. Further, any suitable snow sport helmet that is used for snow sports or similar activities may be used with the snowboard tracking helmet device. Additionally, the helmet component comprises additional components conventionally associated with the different types of helmets, such as internal padding adapted to fit snugly against the user's head, a face shield, etc. Furthermore, the helmet component of the present invention comprises additional padding and insulation to absorb the force of impacts and prevents head injuries and other emergency-type situations.

In one embodiment, the helmet component comprises Bluetooth capabilities which allows users to link up to their smart devices. The snowboard tracking helmet device includes a wireless communications module and additional sensors which would allow the device to pair with a mobile application on a smart device. Once paired, a user could control the snowboard tracking helmet device via the mobile application.

In one embodiment, the helmet component comprises a variety of sensors including a vital sign monitor, oxygen sensor, sensors that receive verbal commands, GPS capabilities, and an impact sensor, etc., or any other suitable sensors as is known in the art disposed on an interior surface of the helmet component. Specifically, the vital sign monitor monitors and detects a user's vitals and communicates with the oxygen sensor and other sensors as needed. Further, the oxygen sensor will communicate with a compact oxygen tank in the presence of low oxygen. Thus, if low oxygen is detected, the oxygen sensor communicates to turn on the compact oxygen tank to provide the user with oxygen, as needed. The compact oxygen tank would be positioned within the helmet component, typically near the back of the helmet component.

In one embodiment, the impact sensors communicate with backpacks equipped for avalanches in case of an emergency and to determine the effect of the impact, a fall, an avalanche, etc., on a user. Specifically, the impact sensors comprise accelerometers or other sensors adapted to detect the magnitude of a force or pressure resulting from an impact to the helmet component. Furthermore, the impact sensors are arranged so that they can detect the varying levels of force imparted upon different regions of the user's head from a single impact. Because a concussion is the result of the compression of the brain against the interior of the skull and this compression is greatest at areas that are subjected to higher magnitude forces, the present invention can indicate the areas of the user's brain at which a concussion is most likely to have occurred, thereby assisting medical personnel in diagnosing and treating a concussion.

In one embodiment, the sensors provide GPS capabilities, which would provide tracking location and map navigation to the user. These sensors can be used in case of an emergency, such as an avalanche or getting lost on a trail while snowboarding.

In one embodiment, the helmet component comprises an avalanche beacon face shield. The face shield can be sized and shaped as a conventional face shield and is typically integral to the helmet component. In one embodiment, the face shield can be removable and replaceable, as needed. Further, the face shield provides a heads-up display to demonstrate various snowboarding tricks in real time, provide a map of the location (via the GPS capabilities) and provide UV protection, as needed. Additionally, the face shield is also fog resistant. Typically, a user would issue verbal commands to activate the features of the heads-up display on the face shield. The verbal commands would be received by the sensors to register and implement the commands.

In one embodiment, the helmet component comprises various components to communicate and interact with the various sensors. Specifically, the helmet component comprises at least one wireless transceiver, a processor, a memory operatively connected to the processor, such that the logic stored within the memory is adapted to be executed by the processor. The various components of the present invention are in wired, (i.e., electrical), or wireless communication in different embodiments of the present invention. In one embodiment of the present invention, the sensors are disposed throughout the interior surface of the helmet component, and the memory, processor, and wireless transceiver are contained within a housing that is either integral to the helmet component or removably attached to the helmet component. The wireless transceiver comprises a direct wireless connection device, (i.e., a Bluetooth connection), or a device that connects to a wireless communication network, (i.e., a Wi-Fi connection or a mobile cellular network).

Further, the logic stored within the memory is adapted to execute a series of actions or instructions based upon data received from the sensors. For example, when the impact sensors detect a force, that information is relayed to the processor, which then executes the logic to analyze the data. Further, the logic causes the processor to activate the wireless transceiver, which uploads the data to a cloud-based storage medium, a remote server, or another such type of remotely accessible storage medium. In an alternative embodiment of the present invention, the logic further causes the memory to store the data for direct retrieval from the helmet component.

In one embodiment of the present invention, the varying sensors are integral to the helmet component. In this embodiment of the present invention, the sensors are in electrical communication with the integral memory, the processor, the wireless transceiver, and other electronic components of the present invention via wiring disposed throughout the helmet component. In another embodiment of the present invention, the sensors are removably affixable to the interior of the helmet component via any removable attachment mechanism known in the prior art, such as hook-and-loop fastening material or adhesive. In this embodiment of the present invention, each of the sensors comprises a wireless transceiver adapted to place the sensors in wireless communication with a memory, a processor, a wireless transceiver, and the other electronic components of the present invention, which may in turn be disposed within a housing that is either integral to the helmet component or removably affixed to the helmet component.

In one embodiment, the snowboard tracking helmet device comprises at least one power source in electrical communication with the various electronic components of the present invention. In one embodiment of the present invention wherein all of the electronic components are integral to the helmet component, the present invention comprises a single power source in electrical communication with all of the electronic components, providing power thereto. In another embodiment of the present invention wherein the sensors are removably affixed to the interior of the helmet component, and the memory, processor, and wireless transceiver are contained within a housing that is removably affixable to the helmet component, each of these separate components comprises an independent power source. The power source of the present invention comprises a removable battery, a battery that is rechargeable, solar cells, or any other suitable power source as is known in the art. In another embodiment, the helmet component comprises a USB port for recharging the rechargeable battery, as needed.

In yet another embodiment, the snowboard tracking helmet device comprises a plurality of indicia.

In yet another embodiment, a method of tracking users via a helmet for better communication and view of the terrain is disclosed. The method includes the steps of providing a snowboard tracking helmet device comprising a helmet component with a variety of sensors. The method also comprises linking up the helmet component to a user's smart phone via Bluetooth. Further, the method comprises utilizing the variety of sensors to track vitals and receive verbal commands. The method also comprises providing a heads-up display on the face shield. Finally, the method comprises utilizing verbal commands to activate the features of the heads-up display.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the snowboard tracking helmet device of the present invention in accordance with the disclosed architecture;

FIG. 2 illustrates a perspective view of one embodiment of the snowboard tracking helmet device of the present invention showing the face shield in accordance with the disclosed architecture;

FIG. 3 illustrates a perspective view of one embodiment of the snowboard tracking helmet device of the present invention showing the multiple sensors within the helmet component in accordance with the disclosed architecture;

FIG. 4 illustrates a perspective view of one embodiment of the snowboard tracking helmet device of the present invention showing the back of the helmet component in accordance with the disclosed architecture;

FIG. 5 illustrates a perspective view of one embodiment of the snowboard tracking helmet device of the present invention showing the top view of the helmet component in accordance with the disclosed architecture; and

FIG. 6 illustrates a flowchart showing the method of tracking users via a helmet for better communication and view of the terrain in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a snowboard tracking helmet device that provides users with a tracking helmet for better communication and view of terrain while snowboarding or skiing. There is also a long felt need in the art for a snowboard tracking helmet device that prevents head injuries and other emergency-type situations by absorbing the force of the impact. Further, there is a long felt need in the art for a snowboard tracking helmet device that features multiple sensors that would detect impact and provide oxygen, if needed, through vital sign detection. Moreover, there is a long felt need in the art for a device that offers tracking location, map navigation, weather alerts, and real-time tutorial demonstrations. Further, there is a long felt need in the art for a snowboard tracking helmet device that enhances communication and improves overall situational awareness. Finally, there is a long felt need in the art for a snowboard tracking helmet device that enables users to communicate and alert emergency response quickly and easily.

The present invention, in one exemplary embodiment, is a novel snowboard tracking helmet device. The snowboard tracking helmet device comprises a helmet component that is configured in a rounded shape similar to a conventional snowboard helmet. The helmet component includes Bluetooth capabilities which allows users to link up to their smart devices and issue verbal commands to activate the features of the heads-up display. The helmet component comprises a variety of sensors including a vital sign monitor, oxygen sensor, sensors that receive verbal commands, GPS capabilities, and an impact sensor. An avalanche beacon face shield on the helmet component provides a heads-up display to demonstrate various snowboarding tricks in real time, provide a map of the location and provide UV protection. The present invention also includes a novel method of tracking users via a helmet for better communication and view of the terrain. The method includes the steps of providing a snowboard tracking helmet device comprising a helmet component with a variety of sensors. The method also comprises linking up the helmet component to a user's smart phone via Bluetooth. Further, the method comprises utilizing the variety of sensors to track vitals and receive verbal commands. The method also comprises providing a heads-up display on the face shield. Finally, the method comprises utilizing verbal commands to activate the features of the heads-up display.

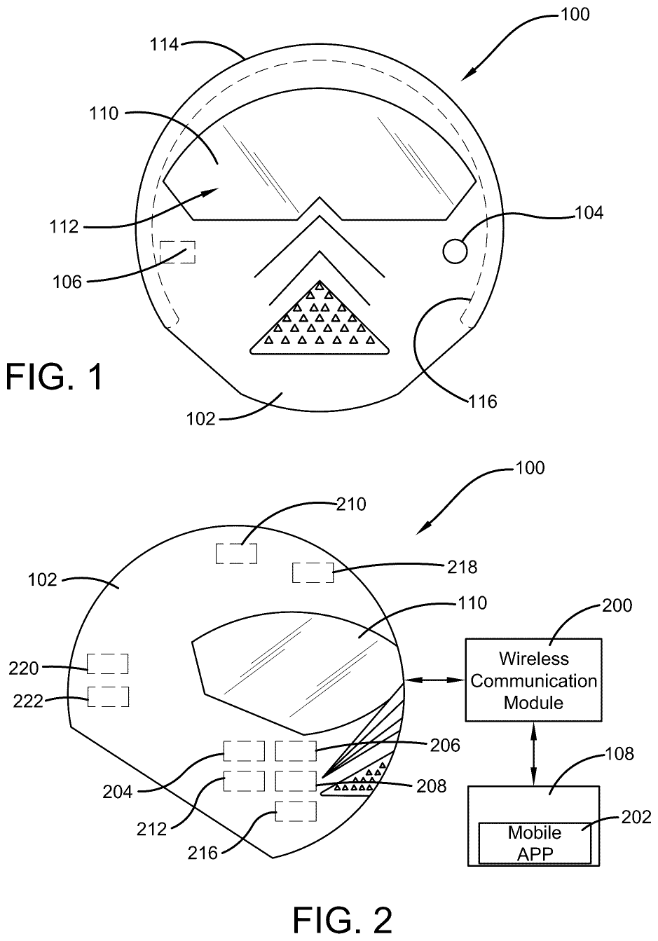

Referring initially to the drawings, FIG. 1 illustrates a perspective view of one embodiment of the snowboard tracking helmet device 100 of the present invention. In the present embodiment, the snowboard tracking helmet device 100 is an improved snowboard tracking helmet device 100 that provides a user with a helmet for snowboarding or skiing with a variety of sensors 104. Specifically, the snowboard tracking helmet device 100 comprises a helmet component 102 and the variety of sensors 104. The helmet component 102 includes Bluetooth capabilities 106 which allows users to link up to their smart devices 108 and issue verbal commands. Further, an avalanche beacon face shield 110 on the helmet component 102 provides a heads-up display 112 to demonstrate various snowboarding tricks in real time, provide a map of the location, and provide UV protection, etc.

Generally, the snowboard tracking helmet device 100 prevents head injuries, suffocation due to avalanches, and facilitates learning new techniques while riding. Further, the snowboard tracking helmet device 100 provides better communication and view of the terrain while snowboarding or skiing. It enhances communication and improves overall situational awareness. Further, it enables users to communicate and alert emergency response quickly and easily. Thus, the device 100 offers tracking location, map navigation, weather alerts and real-time tutorial demonstrations, etc.

Further, the snowboard tracking helmet device 100 comprises a helmet component 102 that is configured in a rounded shape similar to a conventional snowboard helmet. Typically, the helmet component 102 is a snowboard helmet, but can be any suitable snow sport helmet as is known in the art. Further, any suitable snow sport helmet that is used for snow sports or similar activities may be used with the snowboard tracking helmet device 100. Additionally, the helmet component 102 comprises additional components conventionally associated with the different types of helmets, such as internal padding adapted to fit snugly against the user's head, a face shield 110, etc. Furthermore, the helmet component 102 of the present invention comprises an exterior surface 114 and an interior surface 116, wherein additional padding and insulation to absorb the force of impacts and prevents head injuries and other emergency-type situations is included on the interior surface 116. The exterior surface 114 comprises a hard, impact-resistant material, such as plastic.

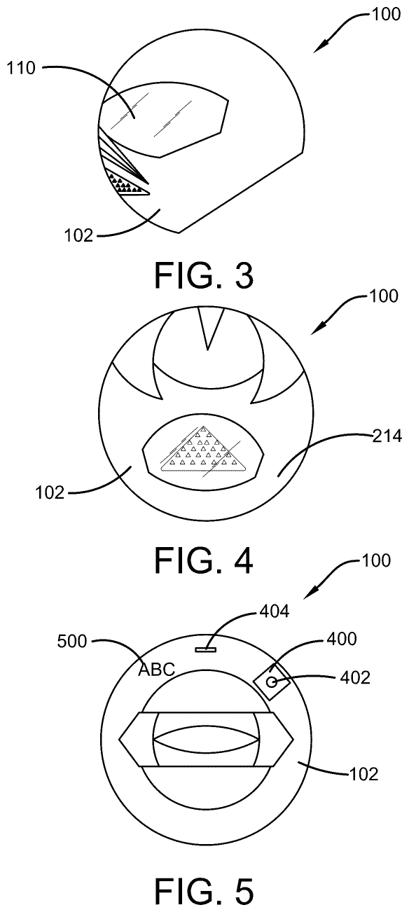

As shown in FIGS. 2-3, the helmet component 102 comprises Bluetooth capabilities 106 which allows users to link up to their smart devices 108. The snowboard tracking helmet device 100 includes a wireless communications module 200 and additional sensors which would allow the device 100 to pair with a mobile application 202 on a smart device 108. Once paired, a user could control the snowboard tracking helmet device 100 via the mobile application 202. Further, the mobile device or smart device 108 may be a cellular telephone, a remote control, or any other device that may have wireless communication capabilities and may be connected to the internet. The mobile or smart device 108 may perform any type of wireless communication, including, but not limited to, WIFI, BLUETOOTH, RFID, NFC, etc. Thus, the wireless communication module 200 and additional sensors allow the device 100 to pair with a mobile application 202 on a mobile or smart device 108. Once paired, a user could control the snowboard tracking helmet device 100 via the mobile application 202.

Further, the helmet component 102 comprises a variety of sensors 104 including a vital sign monitor 204, oxygen sensor 206, sensors that receive verbal commands 208, GPS capabilities 210, and an impact sensor 212, etc., or any other suitable sensors as is known in the art disposed on an interior surface 116 of the helmet component 102. Specifically, the vital sign monitor 204 monitors and detects a user's vitals and communicates with the oxygen sensor 206 and other sensors 104 as needed. Further, the oxygen sensor 206 will communicate with a compact oxygen tank 214 in the presence of low oxygen. Thus, if low oxygen is detected, the oxygen sensor 206 communicates to turn on the compact oxygen tank 214 to provide the user with oxygen, as needed. The compact oxygen tank 214 would be positioned within the helmet component 102, typically near the back of the helmet component 102.

Additionally, the impact sensors 212 communicate with backpacks equipped for avalanches in case of an emergency and to determine the effect of the impact, a fall, an avalanche, etc., on a user. Specifically, the impact sensors 212 comprise accelerometers 216 or other sensors adapted to detect the magnitude of a force or pressure resulting from an impact to the helmet component 102. Furthermore, the impact sensors 212 are arranged so that they can detect the varying levels of force imparted upon different regions of the user's head from a single impact. Because a concussion is the result of the compression of the brain against the interior of the skull and this compression is greatest at areas that are subjected to higher magnitude forces, the present invention can indicate the areas of the user's brain at which a concussion is most likely to have occurred, thereby assisting medical personnel in diagnosing and treating a concussion.

Furthermore, the sensors 104 provide GPS capabilities 210, which would provide tracking location and map navigation to the user. These sensors 104 can be used in case of an emergency, such as an avalanche or getting lost on a trail while snowboarding.

Additionally, the helmet component 102 comprises an avalanche beacon face shield 110. The face shield 110 can be sized and shaped as a conventional face shield and is typically integral to the helmet component 102. In one embodiment, the face shield 110 can be removable and replaceable, as needed. Further, the face shield 110 provides a heads-up display 112 to demonstrate various snowboarding tricks in real time, provide a map of the location (via the GPS capabilities 210) and provide UV protection, as needed. Additionally, the face shield 110 is also fog resistant. Typically, a user would issue verbal commands to activate the features of the heads-up display 112 on the face shield 110. The verbal commands would be received by the sensors 104 to register and implement the commands.

Also, the helmet component 102 comprises various components to communicate and interact with the various sensors 104. Specifically, the helmet component 102 comprises at least one wireless transceiver 218, a processor 220, and a memory 222 operatively connected to the processor 220, such that the logic stored within the memory 222 is adapted to be executed by the processor 220. The various components of the present invention are in wired, (i.e., electrical), or wireless communication in different embodiments of the present invention. In one embodiment of the present invention, the sensors 104 are disposed throughout the interior surface 116 of the helmet component 102, and the memory 222, processor 220, and wireless transceiver 218 are contained within a housing (not shown) that is either integral to the helmet component 102 or removably attached to the helmet component 102. The wireless transceiver 218 comprises a direct wireless connection device, (i.e., a Bluetooth connection 106), or a device that connects to a wireless communication network, (i.e., a Wi-Fi connection or a mobile cellular network).

Further, the logic stored within the memory 222 is adapted to execute a series of actions or instructions based upon data received from the sensors 104. For example, when the impact sensors 212 detect a force, that information is relayed to the processor 220, which then executes the logic to analyze the data. Further, the logic causes the processor 220 to activate the wireless transceiver 218, which uploads the data to a cloud-based storage medium, a remote server, or another such type of remotely accessible storage medium. In an alternative embodiment of the present invention, the logic further causes the memory 222 to store the data for direct retrieval from the helmet component 102.

In one embodiment of the present invention, the varying sensors 104 are integral to the helmet component 102. In this embodiment of the present invention, the sensors 104 are in electrical communication with the integral memory 222, the processor 220, the wireless transceiver 218, and other electronic components of the present invention via wiring disposed throughout the helmet component 102. In another embodiment of the present invention, the sensors 104 are removably affixable to the interior 116 of the helmet component 102 via any removable attachment mechanism known in the prior art, such as hook-and-loop fastening material or adhesive. In this embodiment of the present invention, each of the sensors 104 comprises a wireless transceiver 218 adapted to place the sensors 104 in wireless communication with a memory 222, a processor 220, a wireless transceiver 218, and the other electronic components of the present invention, which may in turn be disposed within a housing that is either integral to the helmet component 102 or removably affixed to the helmet component 102.

As shown in FIGS. 4-5, the snowboard tracking helmet device 100 comprises at least one power source 400 in electrical communication with the various electronic components of the present invention. In one embodiment of the present invention wherein all of the electronic components are integral to the helmet component 102, the present invention comprises a single power source 400 in electrical communication with all of the electronic components, providing power thereto. In another embodiment of the present invention wherein the sensors 104 are removably affixed to the interior 116 of the helmet component 102, and the memory 222, processor 220, and wireless transceiver 218 are contained within a housing that is removably affixable to the helmet component 102, each of these separate components comprises an independent power source 400. The power source 400 of the present invention comprises a removable battery, a battery that is rechargeable 402, solar cells, or any other suitable power source as is known in the art. In another embodiment, the helmet component 102 comprises a USB port 404 for recharging the rechargeable battery 402, as needed.

The rechargeable battery 402 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the snowboard tracking helmet device 100. Throughout this specification, the term “battery” may be used interchangeably to refer to one or more wet or dry cells or batteries of cells in which chemical energy is converted into electricity and used as a source of DC power. References to recharging or replacing the battery 402 may refer to recharging or replacing individual cells, individual batteries of cells, or a package of multiple battery cells as is appropriate for any given battery technology that may be used. In addition, a rechargeable embodiment of the battery 402 may be recharged using a USB port 404, wherein the USB port 404 is a USB-A, USB-B, Micro-B, Micro-USB, Mini-USB, or USB-C port, etc.

In yet another embodiment, the snowboard tracking helmet device 100 comprises a plurality of indicia 500. The helmet component 102 of the device 100 may include advertising, a trademark, or other letters, designs, or characters, printed, painted, stamped, or integrated into the helmet component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be snowboard, sensors, or brand related.

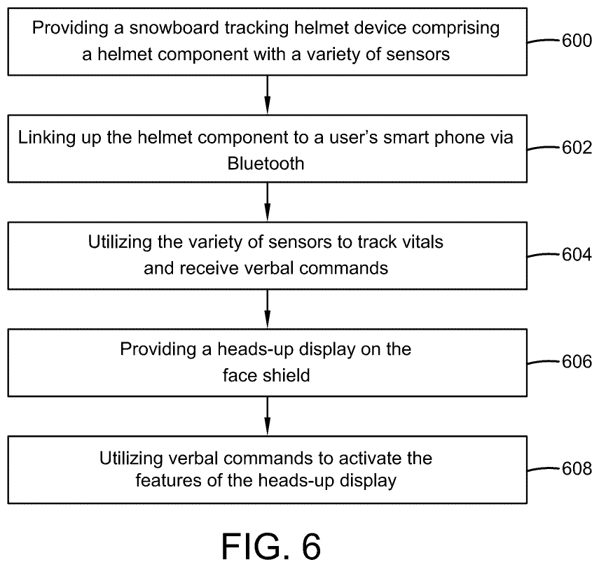

FIG. 6 illustrates a flowchart of the method of tracking users via a helmet for better communication and view of the terrain. The method includes the steps of at 600, providing a snowboard tracking helmet device comprising a helmet component with a variety of sensors. The method also comprises at 602, linking up the helmet component to a user's smart phone via Bluetooth. Further, the method comprises at 604, utilizing the variety of sensors to track vitals and receive verbal commands. The method also comprises at 606, providing a heads-up display on the face shield. Finally, the method comprises at 608, utilizing verbal commands to activate the features of the heads-up display.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “snowboard tracking helmet device”, “snowboard device”, “tracking device”, and “device” are interchangeable and refer to the snowboard tracking helmet device 100 of the present invention.

Notwithstanding the forgoing, the snowboard tracking helmet device 100 of the present invention can be of any suitable size and configuration as is known in the art without affecting the overall concept of the invention, provided that it accomplishes the above stated objectives. One of ordinary skill in the art will appreciate that the snowboard tracking helmet device 100 as shown in FIGS. 1-6 is for illustrative purposes only, and that many other sizes and shapes of the snowboard tracking helmet device 100 are well within the scope of the present disclosure. Although the dimensions of the snowboard tracking helmet device 100 are important design parameters for user convenience, the snowboard tracking helmet device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A snowboard tracking helmet device that provides a user with a helmet for snowboarding or skiing with a variety of sensors, the snowboard tracking helmet device comprising:
a helmet component; and
a plurality of sensors;
wherein the plurality of sensors are positioned on an interior surface of the helmet component;
wherein the helmet component includes a face shield which provides a heads-up display; and
further wherein the plurality of sensors comprise a capability to prevent head injuries, suffocation due to avalanches, facilitates learning new techniques while riding, offers tracking location, map navigation, weather alerts, and real-time tutorial demonstrations.

2. The snowboard tracking helmet device of claim 1, wherein the helmet component is configured in a rounded shape similar to a conventional snowboard helmet.

3. The snowboard tracking helmet device of claim 2, wherein the helmet component comprises internal padding adapted to fit snugly against a user's head.

4. The snowboard tracking helmet device of claim 3, wherein the helmet component comprises Bluetooth capabilities which allows users to link up to their smart devices.

5. The snowboard tracking helmet device of claim 4, wherein the helmet component comprises a wireless communications module and additional sensors which allow the snowboard tracking helmet device to pair with a mobile application on a smart device, once paired, a user could control the snowboard tracking helmet device via the mobile application.

6. The snowboard tracking helmet device of claim 5, wherein the plurality of sensors include a vital sign monitor which monitors and detects a user's vitals.

7. The snowboard tracking helmet device of claim 6, wherein the plurality of sensors include an oxygen sensor which communicates with a compact oxygen tank in the presence of low oxygen.

8. The snowboard tracking helmet device of claim 7, wherein the plurality of sensors include sensors that receive verbal commands.

9. The snowboard tracking helmet device of claim 8, wherein the plurality of sensors include GPS capabilities which provide tracking location and map navigation to the user.

10. The snowboard tracking helmet device of claim 9, wherein the plurality of sensors include impact sensors.

11. The snowboard tracking helmet device of claim 10, wherein the impact sensors comprise accelerometers to detect magnitude of a force or pressure resulting from an impact to the helmet component.

12. The snowboard tracking helmet device of claim 11, wherein the face shield provides a heads-up display which can demonstrate various snowboarding tricks in real time, provide a map of a location and provide UV protection, as needed.

13. The snowboard tracking helmet device of claim 12, wherein the helmet component comprises at least one wireless transceiver, a processor, and a memory operatively connected to the processor, such that logic stored within the memory is adapted to be executed by the processor.

14. A snowboard tracking helmet device that provides a user with a helmet for snowboarding or skiing with a variety of sensors, the snowboard tracking helmet device comprising:
a helmet component configured in a rounded shape similar to a conventional snowboard helmet and having an interior surface; and
a plurality of sensors;
wherein the helmet component comprises Bluetooth capabilities which allows users to link up to their smart devices;
wherein the helmet component comprises a wireless communications module and additional sensors which allows the snowboard tracking helmet device to pair with a mobile application on a smart device, once paired, a user could control the snowboard tracking helmet device via the mobile application;
wherein the helmet component includes a face shield which provides a heads-up display;
wherein the plurality of sensors include a vital sign monitor which monitors and detects a user's vitals;
wherein the plurality of sensors include an oxygen sensor which communicates with a compact oxygen tank in the presence of low oxygen;
wherein the plurality of sensors include GPS capabilities which provide tracking location and map navigation to the user;
wherein the plurality of sensors include impact sensors which include accelerometers;
wherein the face shield provides a heads-up display which can demonstrate various snowboarding tricks in real time, provide a map of a location and provide UV protection, as needed;
wherein the helmet component comprises at least one wireless transceiver, a processor, and a memory operatively connected to the processor, such that logic stored within the memory is adapted to be executed by the processor; and
wherein the plurality of sensors are capable of preventing head injuries, suffocation due to avalanches, facilitate learning new techniques while riding, offer tracking location, map navigation, weather alerts, and real-time tutorial demonstrations.

15. The snowboard tracking helmet device of claim 14, wherein the at least one wireless transceiver, the processor, and the memory are in wired or wireless communication with the head component.

16. The snowboard tracking helmet device of claim 14, wherein the face shield is fog resistant.

17. The snowboard tracking helmet device of claim 14, wherein a user would issue verbal commands to activate features of the heads-up display on the face shield.

18. The snowboard tracking helmet device of claim 14 further comprising a rechargeable battery and USB port as a power source.

19. The snowboard tracking helmet device of claim 14 further comprising a plurality of indicia.

20. A method of tracking users via a helmet for better communication and view of the terrain, the method comprising the following steps:
providing a snowboard tracking helmet device comprising a helmet component with a plurality of sensors;
linking up the helmet component to a user's smart phone via Bluetooth;
utilizing the plurality of sensors to track vitals and receive verbal commands;
providing a heads-up display on the face shield; and
utilizing verbal commands to activate the features of the heads-up display.
